(19) United States
(12) Patent Application Publication
(10) Pub. No.: US 2023/0289558 A1
(43) Pub. Date: Sep. 14, 2023

(54) QUANTIZATION METHOD FOR ACCELERATING THE INFERENCE OF NEURAL NETWORKS

(71) Applicant: TENCENT AMERICA LLC, Palo Alto, CA (US)

(72) Inventor: Weiran Deng, Shenzhen (CN)

(21) Appl. No.: 17/693,270

(22) Filed: Mar. 11, 2022

(51) Int. Cl. G06N 3/04; G06N 3/08; G06N 3/10

(52) U.S. Cl. CPC G06N 3/04; G06N 3/08; G06N 3/10

(57) ABSTRACT

An electronic apparatus performs a method of quantizing a neural network. The method includes: clipping a value used within the neural network beyond a range from a minimum value to a maximum value; simulating a quantization process using the clipped value; updating the minimum value and the maximum value during a training of the neural network to optimize the quantization process; and quantizing the value used within the neural network according to the updated minimum value and the maximum value. In some embodiments, the method of quantizing a neural network further includes minimizing the range during the training.

### TECHNICAL FIELD

The present disclosure relates generally to data processing technologies, and in particular, to quantization method for accelerating the inference of a neural network system.

### BACKGROUND

Quantization in neural networks uses a smaller number of bits to represent the numerical values in the storage and the computation of neural networks. For example, a neural network trained in a 32-bit Floating-Point (FP32) precision format can be converted to a format using 8-bit signed Integers (INT8). That results in a 4-fold reduction in model storage and memory footprint. Additionally, running model inference in INT8 format can be achieved using the Single Instruction Multiple Dataset (SIMD) mechanism, in which a single instruction such as a multiplication can be simultaneously carried out on four 8-bit integers instead of one 32-bit floats. This results in a 75% reduction in computing time.

The primary challenge in converting a neural network model from a FP32 format to a INT8 format is the reduction of model accuracy due to the loss of numerical precision. There are various ways to address this issue: the loss of accuracy can be either recovered to some degree using a post-training quantization (PTQ) or a quantization-aware training (QAT) method. The PTQ method uses a representative training dataset and adjusts the min and max of the quantization range in a FP32 format. In QAT, the min and max values of the quantization range are adjusted, while the weights of the neural network model are fine-tuned during a training process. The common component of PTQ and QAT is that the min and max range of the layer weights and activations being adjusted to facilitate the recovery of the model accuracy loss due to quantization. In practice, the min and max values are updated according to the batch statistics during the training process.

### SUMMARY

To overcome the defects or disadvantages of the above mentioned methods, improved systems and methods of accelerating the inference of a neural network system are needed.

There is no prior work that provided a solution to optimize the min and max values for the quantization range. The existing works use the min and max values statistically summarized during the calibration or training process. This is because the min and max values are not differentiable and therefore cannot be learned from the training process for neural network models.

The main limitation in prior works is that the quantization range determined by the min and max values are statistically summarized during the calibration or training process. While this may suffice if the training data are normalized, many deep learning applications such as Reinforcement Learning (RL) may not have well-defined inputs and therefore the input data are not normalized. In such case, simply summarizing the min and max values of a batch of training data is susceptible to a sudden spike of input data. Hence it subsequently causes some spike in intermediate layers, resulting in dramatic increase of the min and max values of a quantization range, and negatively impacting the training loss and accuracy of a neural network.

A technical problem to be solved by the present invention is that the method and system disclosed herein address the limitations in the prior works and optimize the min and max value of a quantization range. In contrast to the method used in the prior works, the min and max values are formulated in an analytical function that serves the purpose of clipping values beyond the range defined by the min and max values. Additionally, the quantization range is minimized such that the resolution from quantizing floating numbers to integers can be optimized.

Another technical problem to be solved by the present invention is that the method and system disclosed herein quantize neural network models to reduce the computing time in model inferences. A method is introduced to optimize the clipping function that defines the quantization range of the neural network weight parameters and activations. Using this method, the clipping function is optimized such that a narrow quantization range can be reached to ensure an optimal quantization resolution.

According to a first aspect of the present application, a method of quantizing a neural network, including: clipping a value used within the neural network beyond a range from a minimum value to a maximum value; simulating a quantization process using the clipped value; updating the minimum value and the maximum value during a training of the neural network to optimize the quantization process; and quantizing the value used within the neural network according to the updated minimum value and the maximum value.

In some embodiments, the method of quantizing a neural network further includes: minimizing the range during the training.

According to a second aspect of the present application, an electronic apparatus includes one or more processing units, memory and a plurality of programs stored in the memory. The programs, when executed by the one or more processing units, cause the electronic apparatus to perform the one or more methods as described above.

According to a third aspect of the present application, a non-transitory computer readable storage medium stores a plurality of programs for execution by an electronic apparatus having one or more processing units. The programs, when executed by the one or more processing units, cause the electronic apparatus to perform the one or more methods as described above.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

So that the present disclosure can be understood in greater detail, a more particular description may be had by reference to the features of various embodiments, some of which are illustrated in the appended drawings. The appended drawings, however, merely illustrate pertinent features of the present disclosure and are therefore not to be considered limiting, for the description may admit to other effective features.

FIG. 1 is an exemplary computing environment in which one or more network-connected client devices and one or more server systems interact with each other locally or remotely via one or more communication networks, in accordance with some implementations of the present disclosure.

FIG. 2 is an exemplary neural network implemented to process data in a neural network model, in accordance with some implementations of the present disclosure.

FIG. 3A shows an exemplary symmetrical clipping scenario for α and β to shape the clipping function, in accordance with some implementations of the present disclosure.

FIG. 3B shows an exemplary asymmetric clipping scenario for α and β to shape the clipping function, in accordance with some implementations of the present disclosure.

FIG. 3C shows an exemplary positive clipping scenario for α and β to shape the clipping function, in accordance with some implementations of the present disclosure.

FIG. 3D shows an exemplary negative clipping scenario for α and β to shape the clipping function, in accordance with some implementations of the present disclosure.

FIG. 4 illustrates the workflow and structural components of a neural network quantization method, in accordance with some implementations of the present disclosure.

FIG. 5 is a block diagram illustrating an exemplary process of quantizing a neural network in accordance with some implementations of the present disclosure.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

Reference will now be made in detail to specific implementations, examples of which are illustrated in the accompanying drawings. In the following detailed description, numerous non-limiting specific details are set forth in order to assist in understanding the subject matter presented herein. But it will be apparent to one of ordinary skill in the art that various alternatives may be used without departing from the scope of claims and the subject matter may be practiced without these specific details. For example, it will be apparent to one of ordinary skill in the art that the subject matter presented herein can be implemented on many types of electronic devices.

Before the embodiments of the present application are further described in detail, names and terms involved in the embodiments of the present application are described, and the names and terms involved in the embodiments of the present application have the following explanations.
NN: Neural Networks
FP32: 32-bit Floating Point
INT8: 8-bit Integer
PTQ: Post-Training Quantization
QAT: Quantization-Aware Training
SIMD: Single Instruction Multiple Data
SGD: Stochastic Gradient Descend
RL: Reinforcement Learning
min: minimum
max: maximum

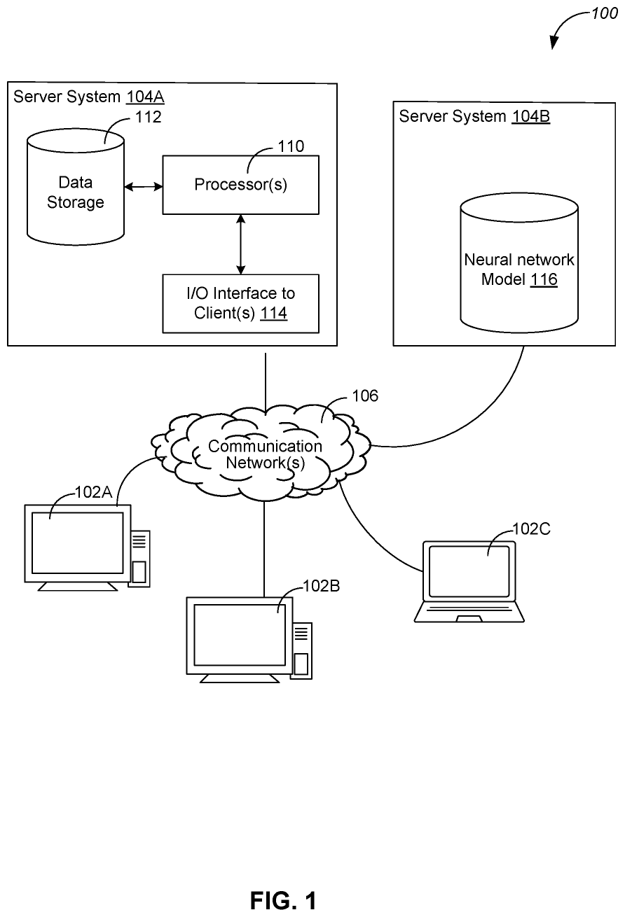

FIG. 1 is an exemplary computing environment 100 in which one or more network-connected client devices 102 and one or more server systems 104 interact with each other locally or remotely via one or more communication networks 106, in accordance with some implementations of the present disclosure.

In some embodiments, the server systems 104, such as 104A and 104B are physically remote from, but are communicatively coupled to the one or more client devices 102. In some embodiments, a client device 102 (e.g., 102A, 102B) includes a desktop computer. In some embodiments, a client device 102 (e.g., 102C) includes a mobile device, e.g., a mobile phone, a tablet computer and a laptop computer. Each client device 102 can collect data or user inputs, execute user applications, and present outputs on its user interface. The collected data or user inputs can be processed locally at the client device 102 and/or remotely by the server(s) 104. Each client device 102 communicates with another client device 102 or the server systems 104 using the one or more communication networks 106. The communication networks 106 can be one or more networks having one or more types of topologies, including but not limited to the Internet, intranets, local area networks (LANs), cellular networks, Ethernet, telephone networks, Bluetooth personal area networks (PAN), and the like. In some embodiments, two or more client devices 102 in a sub-network are coupled via a wired connection, while at least some client devices 102 in the same sub-network are coupled via a local radio communication network (e.g., ZigBee, Z-Wave, Insteon, Bluetooth, Wi-Fi and other radio communication networks). In an example, a client device 102 establishes a connection to the one or more communication networks 106 either directly (e.g., using 3G/4G connectivity to a wireless carrier), or through a network interface (e.g., a router, switch, gateway, hub, or an intelligent, dedicated whole-home control node), or through any combination thereof.

Each of the server systems 104 includes one or more processors 110 and memory storing instructions for execution by the one or more processors 110. The server system 104 also includes an input/output interface to the client(s) as 114. The one or more server systems 104 provide system data (e.g., boot files, operating system images, and user applications) to the client devices 102, and in some embodiments, process the data and user inputs received from the client device(s) 102 when the user applications are executed on the client devices 102. The one or more server systems 104 can enable real-time data communication with the client devices 102 that are remote from each other or from the one or more server systems 104. The server system 104A is configured to store a data storage 112. The server system 104B is configured to store a neural network model 116. In some embodiments, the neural network model and the data storage can be in the same server 104. A neural network training method can be implemented at one or more of the server systems 104.

Each client device 102 includes one or more processors and memory storing instructions for execution by the one or more processors. The instructions stored on the client device 102 enable implementation of the web browser and user interface application to servers 104. The web browser and the user interface application are linked to a user account in the computing environment 100.

Neural network training techniques are applied in the computing environment 100 to process data obtained by an application executed at a client device 102 or loaded from another data storage or files to identify information contained in the data, match the data with other data, categorize the data, or synthesize related data. Data can include text, images, audios, videos, etc. The neural network models are trained with training data before they are applied to process the data. In some embodiments, a neural network model training method is implemented at a client device 102. In some embodiment, a neural network model training method is jointly implemented at the client device 102 and the server system 104. In some embodiments, a neural network model can be held at a client device 102. In some embodiments, the client device 102 is configured to automatically and without user intervention, identify, classify or modify the data information from the data storage 112 or from the neural network model 116.

In some embodiments, both model training and data processing are implemented locally at each individual client device 102 (e.g., the client device 102C). The client device 102C obtains the training data from the one or more server systems 104 including the data storage 112 and applies the training data to train the neural network models. Subsequently to model training, the client device 104C obtains the and processes the data using the trained neural network models locally. Alternatively, in some embodiments, both model training and data processing are implemented remotely at a server system 104 (e.g., the server system 104B) associated with a client device 102 (e.g. the client device 102A). The server 104B obtains the training data from itself, another server 104 or the data storage 112 and applies the training data to train the neural network models 116. The client device 102A obtains the data, sends the data to the server 104B (e.g., in an application) for data processing using the trained neural network models, receives data processing results from the server 104B, and presents the results on a user interface (e.g., associated with the application). The client device 102A itself implements no or little data processing on the data prior to sending them to the server 104B. Additionally, in some embodiments, data processing is implemented locally at a client device 102 (e.g., the client device 102B), while model training is implemented remotely at a server system 104 (e.g., the server 104B) associated with the client device 102B. The trained neural network models are optionally stored in the server 104B or another data storage, such as 112. The client device 102B imports the trained neural network models from the server 104B or data storage 112, processes the data using the neural network models, and generates data processing results to be presented on a user interface locally.

The neural network model system 116 includes one or more of a server, a client device, a storage, or a combination thereof. The neural network model system 116, typically, includes one or more processing units (CPUs), one or more network interfaces, memory, and one or more communication buses for interconnecting these components (sometimes called a chipset). The neural network model system 116 includes one or more input devices that facilitate user input, such as a keyboard, a mouse, a voice-command input unit or microphone, a touch screen display, a touch-sensitive input pad, a gesture capturing camera, or other input buttons or controls. The neural network model system 116 also includes one or more output devices that enable presentation of user interfaces and display content, including one or more speakers and/or one or more visual displays.

Memory includes high-speed random access memory, such as DRAM, SRAM, DDR RAM, or other random access solid state memory devices; and, optionally, includes non-volatile memory, such as one or more magnetic disk storage devices, one or more optical disk storage devices, one or more flash memory devices, or one or more other non-volatile solid state storage devices. Memory, optionally, includes one or more storage devices remotely located from one or more processing units. Memory, or alternatively the non-volatile memory within memory, includes a non-transitory computer readable storage medium. In some embodiments, memory, or the non-transitory computer readable storage medium of memory, stores programs, modules, and data structures including operating system, input processing module for detecting and processing input data, model training module for receiving training data and establishing a neural network model for processing data, neural network module for processing data using neural network models, etc.

Each of the above identified elements may be stored in one or more of the previously mentioned memory devices, and corresponds to a set of instructions for performing a function described above. The above identified modules or programs (i.e., sets of instructions) need not be implemented as separate software programs, procedures, modules or data structures, and thus various subsets of these modules may be combined or otherwise re-arranged in various embodiments. In some embodiments, memory, optionally, stores a subset of the modules and data structures identified above. Furthermore, memory, optionally, stores additional modules and data structures not described above.

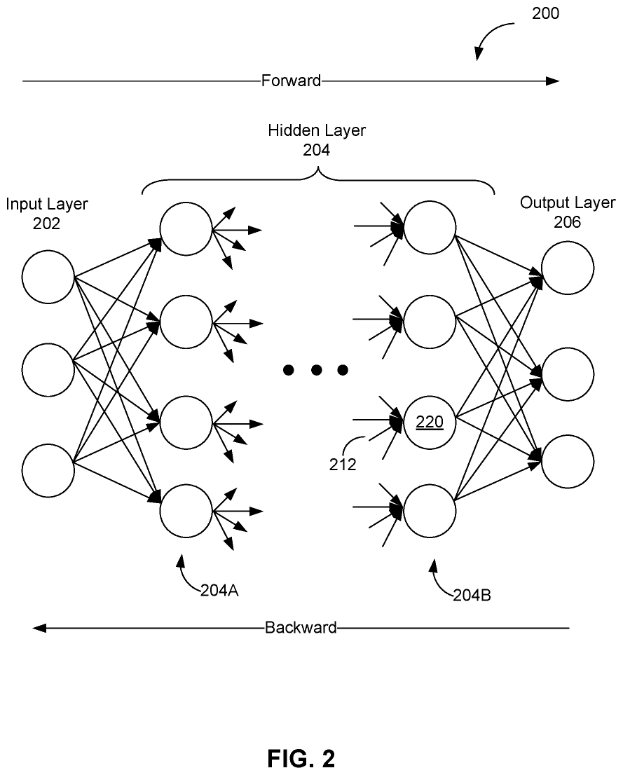

FIG. 2 is an exemplary neural network 200 implemented to process data in a neural network model 116, in accordance with some implementations of the present disclosure. The neural network model 116 is established based on the neural network 200. A corresponding model-based processing module within the server system 104B applies the neural network model 116 including the neural network 200 to process data.

In some examples, the neural network 200 includes a collection of neuron nodes 220 that are connected by links 212. Each neuron node 220 receives one or more neuron node inputs and applies a propagation function to generate a neuron node output from the one or more neuron node inputs. As the neuron node output is transmitted through one or more links 212 to one or more other neuron nodes 220, a weight associated with each link 212 is applied to the neuron node output. The one or more neuron node inputs are combined based on corresponding weights according to the propagation function. In an example, the propagation function is a product of a non-linear activation function and a linear weighted combination of the one or more neuron node inputs.

The neural network consists of one or more layers with the neuron nodes 220. In some embodiments, the one or more layers include a single layer acting as both an input layer and an output layer. In some embodiments, the one or more layers include an input layer 202 for receiving inputs, an output layer 206 for generating outputs, and zero or more hidden layers/latent layers 204 (e.g., 204A and 204B) between the input and output layers 202 and 206. A deep neural network has more than one hidden layers 204 between the input and output layers 202 and 206. In the neural network 200, each layer is only connected with its immediately preceding and/or immediately following layer. In some embodiments, a layer 202 or 204B is a fully connected layer because each neuron node 220 in the layer 202 or 204B is connected to every neuron node 220 in its immediately following layer.

In some embodiments, one or more neural networks can be utilized by the neural network model 116. The one or more neural networks include a fully connected neural network, Multi-layer Perceptron, Convolution Neural Network, Recurrent Neural Networks, Feed Forward Neural Network, Radial Basis Functional Neural Network, LSTM—Long Short-Term Memory, Auto encoders, and Sequence to Sequence Models, etc.

The training process is a process for calibrating all of the weights for each layer of the learning model using a training data set which is provided in the input layer 202. The training process typically includes two steps, forward propagation and backward propagation, which are repeated multiple times until a predefined convergence condition is satisfied. In the forward propagation, the set of weights for different layers are applied to the input data and intermediate results from the previous layers. In the backward propagation, a margin of error of the output (e.g., a loss function) is measured, and the weights are adjusted accordingly to decrease the error. The activation function is optionally linear, rectified linear unit, sigmoid, hyperbolic tangent, or of other types. In some embodiments, a network bias term is added to the sum of the weighted outputs from the previous layer before the activation function is applied. The network bias provides a perturbation that helps the neural network 200 avoid over fitting the training data. The result of the training includes the network bias parameter for each layer.

The method and system disclosed herein have many advantages. For example, the differentiable (or trainable or learnable) min and max quantization parameters are more robust to fluctuations in input data and can quantize a neural network model to a higher accuracy compared to the quantization techniques where the quantization parameters are simply statistically summarized from batch data.

In some embodiments, the clipping function disclosed herein is a generalized solution and applicable to symmetrical or asymmetrical quantization.

In some embodiments, the clipping function can be applied with an additional L2 regularization method during the training process to minimize the quantization range determined by the min and max values and to increase the quantization resolution.

In some embodiments, the values of the present methods and systems are applied to the weights and intermediate features in neural networks. A value is not affected if it falls within in the range between the min and max. The analytical function is defined as below:

$$f ( x ) = \frac{\vert x - a \vert - \vert x - β \vert}{2} sign ( β - α ) + \frac{a + β}{2} . \qquad Eq - 1$$

where α and β define the min and max of the quantization range. Whether α or β is the min or max of the quantization range is not predetermined. Instead, they are determined by the training process of the neural networks. This gives the neural network training process some flexibility of not imposing any inequality constraints such as requiring that α is greater than β. Instead, their values are automatically updated during backpropagation using an optimization method such as Stochastic Gradient Descent (SGD).

In some embodiments, the analytical clipping function has the following features.

$$\cdot If α > β ,$$

$$f ( x ) = \{ \begin{matrix}β , & x ∈ ( - ∞ , β ) \\ x , & x ∈ [ β , α ) \\ α , & x ∈ [ α , ∞ )\end{matrix}$$

$$\cdot If α < β ,$$

$$f ( x ) = \{ \begin{matrix}α , & x ∈ ( - ∞ , α ) \\ x , & x ∈ [ α , β ) \\ β , & x ∈ [ β , ∞ )\end{matrix}$$

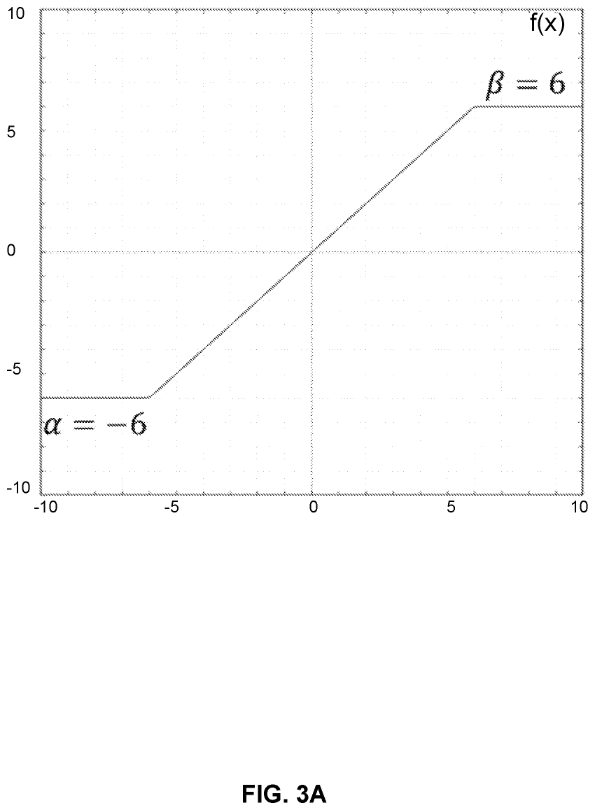

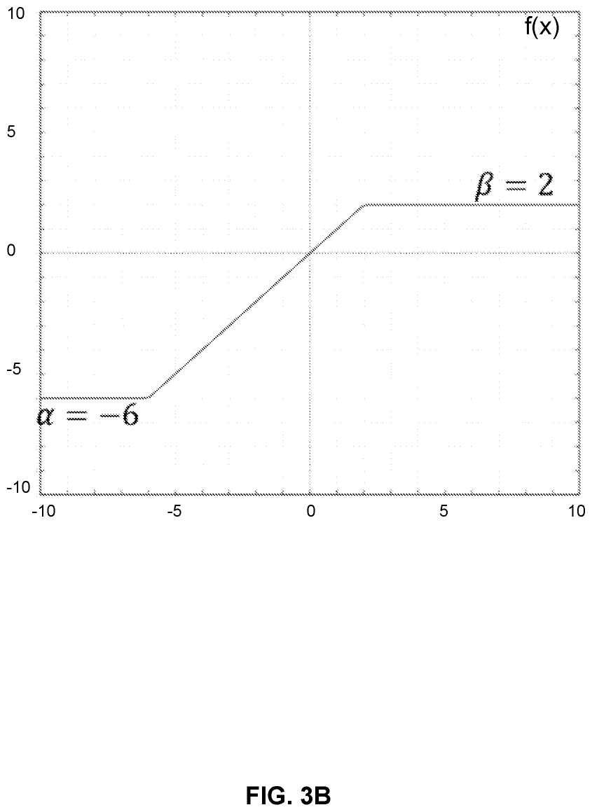

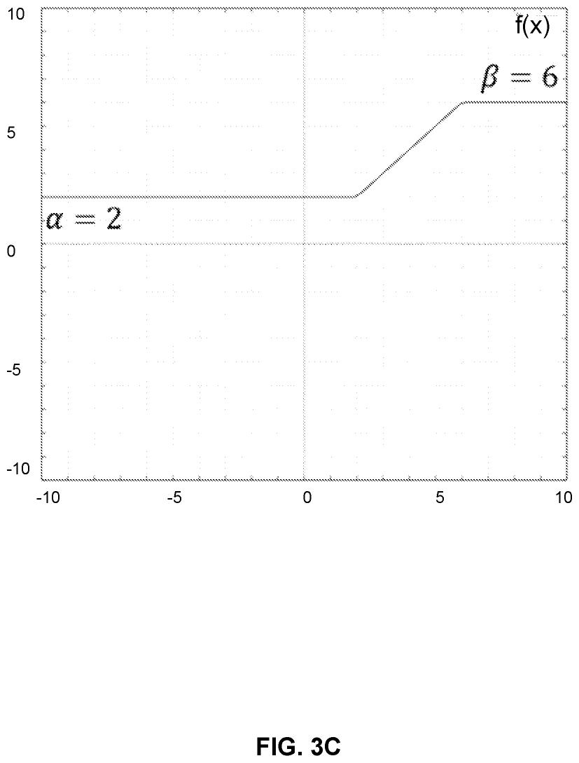

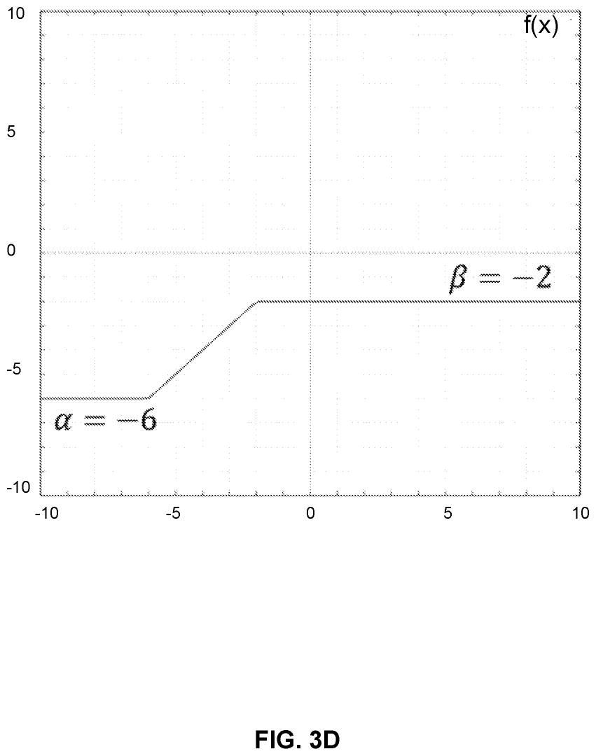

In some examples, the min and max values are automatically determined during the training process. FIGS. 3A-3D show different scenarios of how different α and β shape the clipping function, in accordance with some implementations of the present disclosure. FIG. 3A shows an exemplary symmetrical clipping scenario for α and β to shape the clipping function, in accordance with some implementations of the present disclosure. For example, α=−6 and β=6. FIG. 3B shows an exemplary asymmetric clipping scenario for α and β to shape the clipping function, in accordance with some implementations of the present disclosure. For example, α=−6 and β=2. FIG. 3C shows an exemplary positive clipping scenario for α and β to shape the clipping function, in accordance with some implementations of the present disclosure. For example, α=2 and β=6. FIG. 3D shows an exemplary negative clipping scenario for α and β to shape the clipping function, in accordance with some implementations of the present disclosure. For example, α=−6 and β=−2.

In some embodiments, in conjunction to the analytical clipping function, an additional technique is used to minimize the range determined by α and β, namely, |α−β|. For example, an L2 regularization method to minimize the range of quantization is applied to the loss function:

arg minₓ{Σₗ∥αₗ−βₗ∥²} Eq-2.

In some embodiments, the goal of the L2 regularization method is to constrain the model that has an optimal and minimal quantization range for the parameters and the activations for every layer within the network.

In some embodiments, a new analytical function is used to define a generalized differentiable min and max values for quantizing the neural network models. It provides symmetrical or asymmetrical quantization and introduces a more robust solution to the loss of accuracy caused by the spikes in input data and activations in intermediate layers.

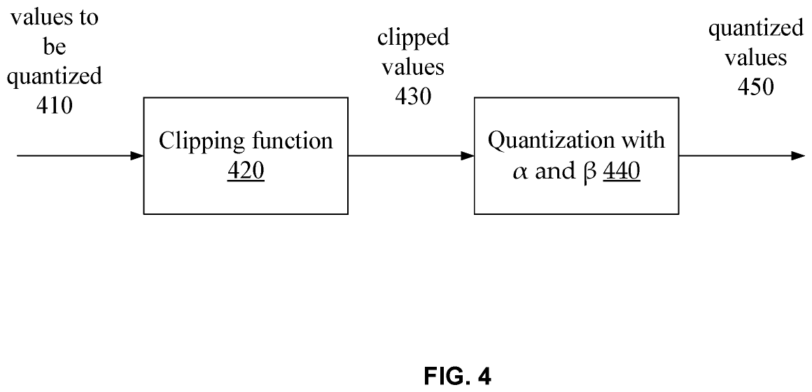

FIG. 4 illustrates the workflow and structural components of a neural network quantization method, in accordance with some implementations of the present disclosure.

In some embodiments, values to be quantized 410 are fed into the clipping function 420. The clipped values 430 from the clipping function 420 is further fed into a quantization process with α and β 440, and the output of the quantization process 440 is the quantized values 450.

In some embodiments, personal computers (PCs) or mobile devices run the neural network model training and inference.

In some embodiments, the quantization process follows the following steps. First, for each layer in the neural network, the layer parameters and activations (for example, values to be quantized 410 as shown in FIG. 4) are fed into the clipping function defined in Eq. 1 (for example, the clipping function 420 as shown in FIG. 4), respectively in the forward propagation stage. The method clips the values (for example, values to be quantized 410 as shown in FIG. 4) to the range of the min and max values determined by the clipping function (for example, the clipping function 420 as shown in FIG. 4) with the parameters α and β.

Second, the weight parameters and the intermediate activations in each layer (for example, clipped values 430 as shown in FIG. 4) are quantized using a fake or simulation quantization method in which the computation is still performed in a FP32 format but quantized to INT8 values (for example, quantized values 450 as shown in FIG. 4) to mimic the behavior of INT8 computations. In the fake or simulation quantization method, the quantization process is mimicked.

In some embodiments, an L2 regularization method is added to the loss that optimizes the model accuracy as shown in Eq. 2. In some examples, the L2 regularization is optional and can be used to minimize the quantization range to give an optimal high quantization resolution.

In some embodiments, during the training process, the min and max values are updated jointly with the neural network weight parameters through the backpropagation using gradient based numerical methods such as SGD. The method updates the values of α and β during the training process to converge to an optimal solution (for example, quantization process with α and β 440 as shown in FIG. 4).

In some embodiments, the structural components of the disclosed method interact with each other. For example, in the forward propagation, the output from the clipping function is fed into the simulation quantization process. In the backward propagation, the training process updates the α and β values. The L2 regularization is part of the loss function that guides the optimization of α and β values.

In some embodiments, the data used in the method and system disclosed herein includes the input training data and the neural network weight parameters. Both types of data are quantized such that the computation in model inference can be carried in the desired quantization format such as from FP32 to INT8. In each layer, the values to be quantized such as the layer weights and activations are first clipped using the clipping function shown in Eq-1, and then the clipped values are quantized using a fake quantization method to mimic the quantization process. After the calibration in PTQ or the training in QAT is complete, the model input and model weights are converted from FP32 into INT8 so that the model storage and inference are conducted in the target format such as INT8.

Alternatively, in some embodiments, the quantization can be applied in a channel-wise fashion so that each channel has its own quantization parameters. For example, if a layer is a 2D convolution layer with its weight dimension as [Nₖ, Nₖ, Nᵢ, Nₒ], the input activation dimension as [Nₓ, N_{y}, Nᵢ], and the output activation dimension as [N′ₓ, N′_{y}, N′ₒ], in the commonly used layer-wise quantization, quantization parameters are three pairs of scalars that are applied to the weights, the input activation, and the output activation, respectively. In a channel-wise quantization, a pair of scalar quantization parameters is replaced with a pair of vectors with each element being aligned with the channel dimension and each channel being quantized by a different range.

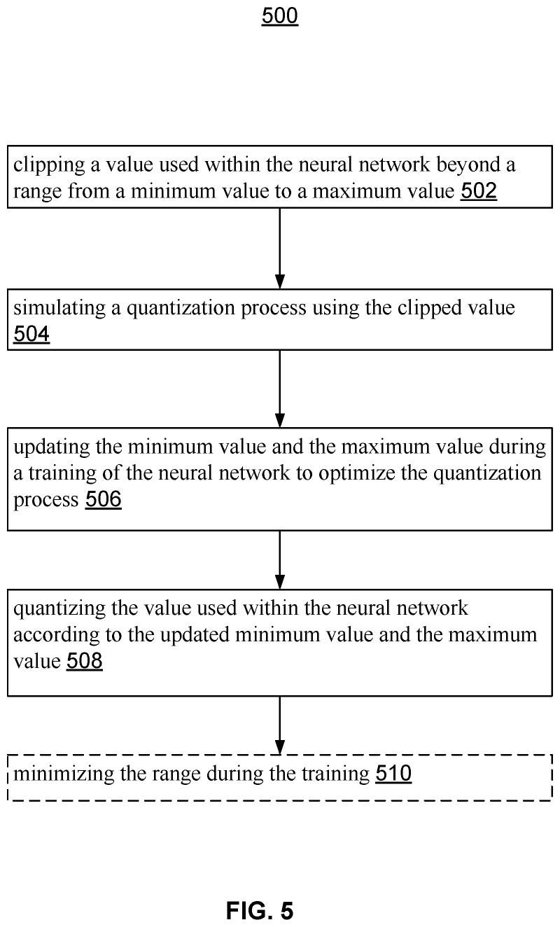

FIG. 5 is a block diagram illustrating an exemplary process 500 of quantizing a neural network in accordance with some implementations of the present disclosure.

The process 500 of quantizing a neural network includes a step 502 of clipping a value used within the neural network beyond a range from a minimum value to a maximum value.

The process 500 includes a step 504 of simulating a quantization process using the clipped value.

The process 500 then includes a step 506 of updating the minimum value and the maximum value during a training of the neural network to optimize the quantization process.

The process 500 additionally includes a step 508 of quantizing the value used within the neural network according to the updated minimum value and the maximum value.

For example, the min and max values are formulated in an analytical function that serves the purpose of clipping values beyond the range defined by the min and max values. The values apply to the values of weight and intermediate features in neural networks

In some embodiments, the process 500 additionally includes a step 510 of minimizing the range during the training. For example, the quantization range is minimized such that the resolution from quantizing floating numbers to integers can be optimized.

In some embodiments, the value used within the neural network includes one or more values of weight, layer activation, and intermediate feature in the neural network. For example, the values apply to the values of weight and intermediate features in neural networks. The values to be quantized such as the layer weights and the layer activations are first clipped using the clipping function.

In some embodiments, clipping the value used within the neural network beyond the range from the minimum value to the maximum value (502) is performed by a clipping function:

$$f ( x ) = \{ \begin{matrix}α , & x ∈ ( - ∞ , α ) \\ x , & x ∈ [ α , β ) \\ β , & x ∈ [ β , ∞ )\end{matrix}$$

wherein α is the minimum value, β is the maximum value, x is the value used within the neural network, and f(x) is the clipping function. For example, a value is not affected if it falls within in the range between the min and max.

In some embodiments, clipping the value used within the neural network beyond the range from the minimum value to the maximum value (502) includes at least one of symmetrical clipping, asymmetric clipping, positive clipping, and negative clipping. For example, the min and max values are automatically determined during the training and the FIGS. 1A-1D show different scenarios of how different α and β shape the clipping function.

In some embodiments, minimizing the range during the training (510) includes: minimizing the range during the training using an L2 regularization applied to a loss function during the training. For example, the clipping function can be applied with an additional L2 regularization during the training to minimize the range determined by the min/max range and to increase the quantization resolution. An additional technique is used to minimize the range determined by α and β, namely, |α−β. An L2 regularization for minimizing the range of quantization is applied to the loss function.

In some embodiments, clipping the value used within the neural network beyond the range from the minimum value to the maximum value (502) is performed in a forward propagation.

In some embodiments, updating the minimum value and the maximum value during the training of the neural network to optimize the quantization process (506) is performed in a backward propagation.

In some embodiments, simulating the quantization process using the clipped value (504) includes computing simulated quantization in FP32 format and quantizing the clipped values to INT8 format. For example, the weight parameters and the intermediate activations in each layer are quantized using a fake quantization method in which the computation is still performed in FP32 format but quantized to INT8 values to mimic the behavior of INT8 computations.

In some embodiments, clipping the value used within the neural network beyond the range from the minimum value to the maximum value (502) includes: clipping a respective value used within the neural network beyond a respective range from a respective minimum value to a respective maximum value for each channel of a plurality of channels. For example, the quantization can be applied in a channel-wise fashion that each channel has its own quantization parameters. In a channel-wise quantization, a pair of scalar quantization parameter is replaced with a pair of vectors with each element aligned with the channel dimension and each channel quantized by a different range.

Further embodiments also include various subsets of the above embodiments including embodiments as shown in FIGS. 1-5 combined or otherwise re-arranged in various other embodiments.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media that is non-transitory or (2) a communication medium such as a signal or carrier wave. Data storage media may be any available media that can be accessed by one or more computers or one or more processors to retrieve instructions, code and/or data structures for implementation of the implementations described in the present application. A computer program product may include a computer-readable medium.

The terminology used in the description of the implementations herein is for the purpose of describing particular implementations only and is not intended to limit the scope of claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, elements, and/or components, but do not preclude the presence or addition of one or more other features, elements, components, and/or groups thereof.

It will also be understood that, although the terms first, second, etc. may be used herein to describe various elements, these elements should not be limited by these terms. These terms are only used to distinguish one element from another. For example, a first electrode could be termed a second electrode, and, similarly, a second electrode could be termed a first electrode, without departing from the scope of the implementations. The first electrode and the second electrode are both electrodes, but they are not the same electrode.

The description of the present application has been presented for purposes of illustration and description, and is not intended to be exhaustive or limited to the invention in the form disclosed. Many modifications, variations, and alternative implementations will be apparent to those of ordinary skill in the art having the benefit of the teachings presented in the foregoing descriptions and the associated drawings. The embodiment was chosen and described in order to best explain the principles of the invention, the practical application, and to enable others skilled in the art to understand the invention for various implementations and to best utilize the underlying principles and various implementations with various modifications as are suited to the particular use contemplated. Therefore, it is to be understood that the scope of claims is not to be limited to the specific examples of the implementations disclosed and that modifications and other implementations are intended to be included within the scope of the appended claims.

What is claimed is:

1. A method of quantizing a neural network, comprising:
clipping a value used within the neural network beyond a range from a minimum value to a maximum value;
simulating a quantization process using the clipped value;
updating the minimum value and the maximum value during a training of the neural network to optimize the quantization process; and
quantizing the value used within the neural network according to the updated minimum value and the maximum value.

2. The method according to claim 1, further comprising:
minimizing the range during the training.

3. The method according to claim 1, wherein the value used within the neural network includes one or more values of weight, layer activation, and intermediate feature in the neural network.

4. The method according to claim 1, wherein clipping the value used within the neural network beyond the range from the minimum value to the maximum value is performed by a clipping function:
$$f ( x ) = \{ \begin{matrix}α , & x ∈ ( - ∞ , α ) \\ x , & x ∈ [ α , β ) \\ β , & x ∈ [ β , ∞ )\end{matrix}$$
wherein α is the minimum value, β is the maximum value, x is the value used within the neural network, and f(x) is the clipping function.

5. The method according to claim 1, wherein clipping the value used within the neural network beyond the range from the minimum value to the maximum value includes at least one of symmetrical clipping, asymmetric clipping, positive clipping, and negative clipping.

6. The method according to claim 2, wherein minimizing the range during the training includes:
minimizing the range during the training using an L2 regularization applied to a loss function during the training.

7. The method according to claim 1, wherein clipping the value used within the neural network beyond the range from the minimum value to the maximum value is performed in a forward propagation.

8. The method according to claim 1, wherein updating the minimum value and the maximum value during the training of the neural network to optimize the quantization process is performed in a backward propagation.

9. The method according to claim 1, wherein simulating the quantization process using the clipped value includes computing simulated quantization in FP32 format and quantizing the clipped values to INT8 format.

10. The method according to claim 1, wherein clipping the value used within the neural network beyond the range from the minimum value to the maximum value includes: clipping a respective value used within the neural network beyond a respective range from a respective minimum value to a respective maximum value for each channel of a plurality of channels.

11. An electronic apparatus comprising one or more processing units, memory coupled to the one or more processing units, and a plurality of programs stored in the memory that, when executed by the one or more processing units, cause the electronic apparatus to perform a plurality of operations of quantizing a neural network, comprising:
clipping a value used within the neural network beyond a range from a minimum value to a maximum value;
simulating a quantization process using the clipped value;
updating the minimum value and the maximum value during a training of the neural network to optimize the quantization process; and
quantizing the value used within the neural network according to the updated minimum value and the maximum value.

12. The electronic apparatus according to claim 11, wherein the plurality of operations of quantizing a neural network, further comprising:
minimizing the range during the training.

13. The electronic apparatus according to claim 11, wherein the value used within the neural network includes one or more values of weight, layer activation, and intermediate feature in the neural network.

14. The electronic apparatus according to claim 11, wherein clipping the value used within the neural network beyond the range from the minimum value to the maximum value is performed by a clipping function:
$$f ( x ) = \{ \begin{matrix}α , & x ∈ ( - ∞ , α ) \\ x , & x ∈ [ α , β ) \\ β , & x ∈ [ β , ∞ )\end{matrix}$$
wherein α is the minimum value, β is the maximum value, x is the value used within the neural network, and f(x) is the clipping function.

15. The electronic apparatus according to claim 11, wherein clipping the value used within the neural network beyond the range from the minimum value to the maximum value includes at least one of symmetrical clipping, asymmetric clipping, positive clipping, and negative clipping.

16. The electronic apparatus according to claim 11, wherein minimizing the range during the training includes:
minimizing the range during the training using an L2 regularization applied to a loss function during the training.

17. The electronic apparatus according to claim 11, wherein clipping the value used within the neural network beyond the range from the minimum value to the maximum value is performed in a forward propagation.

18. The electronic apparatus according to claim 11, wherein updating the minimum value and the maximum value during the training of the neural network to optimize the quantization process is performed in a backward propagation.

19. A non-transitory computer readable storage medium storing a plurality of programs for execution by an electronic apparatus having one or more processing units, wherein the plurality of programs, when executed by the one or more processing units, cause the electronic apparatus to perform a plurality of operations of quantizing a neural network, comprising:
clipping a value used within the neural network beyond a range from a minimum value to a maximum value;
simulating a quantization process using the clipped value;
updating the minimum value and the maximum value during a training of the neural network to optimize the quantization process; and
quantizing the value used within the neural network according to the updated minimum value and the maximum value.

20. The non-transitory computer readable storage medium according to claim 19, wherein the plurality of operations of quantizing a neural network, further comprising:
minimizing the range during the training.
